(19) United States
(12) Patent Application Publication
(10) Pub. No.: US 2026/0110575 A1
(43) Pub. Date: Apr. 23, 2026

(54) LIGHT SOURCE ARRANGEMENT FOR IMPROVED SENSITIVITY MEASUREMENTS OF AMBIENT LIGHT AND COLOR SENSORS AND METHOD FOR PROVIDING SUCH A LIGHT SOURCE ARRANGEMENT

(71) Applicant: ams-OSRAM Asia Pacific Pte. Ltd., Singapore (SG)

(72) Inventors: Curd TRATTLER, Gratwein-Straßengel (AT); Werner RAUCH, Söding (AT)

(21) Appl. No.: 19/136,150

(22) PCT Filed: Dec. 6, 2023
(86) PCT No.: PCT/SG2023/050816

§ 371 Date: Jun. 5, 2025

(30) Foreign Application Priority Data
Dec. 6, 2022 (DE) 10 2022 132 408.7

(51) Int. Cl. G01J 3/50; G01J 1/08

(52) U.S. Cl. CPC G01J 3/501; G01J 1/08

(57) ABSTRACT

A light source arrangement, for sensitivity measurements of color and ambient light sensors, includes a light source and at least one spectral filter. The at least one filter is built to supress at least partly at least one part of spectrum of said light source in a prescribed way.

### TECHNICAL FIELD OF THE DISCLOSURE

The invention relates to light source arrangements for sensitivity measurement of sensors. It more specifically relates to light source arrangements for sensitivity measurements of ambient light and color sensors.

### BACKGROUND

Ambient light sensors and color sensors are nowadays used in many electronic devices. Ambient light sensors are for example used in mobile devices. The detection of the intensity of ambient light allows to adjust to brightness of the display accordingly. In this way, in darker environments, the display can be dimmed, and energy can be saved. Typical applications for these sensors are monitor calibration, display adjustment, lighting scenes adjustments (photographer), and camera white balance.

These sensors need to be tested with respect to their sensitivity in order to assess their capability to fulfil desired functions in various applications.

Prior art test devices for these sensitivity measurements employ LED light sources for sensitivity measurements. The high blue peak and moderate peak in green and red in the spectrum of the LED source cause high variation of the sensitivity measurement. Sensitivity measurements done with a LED result in huge variations of the sensitivity specification. A possibly suitable light source would be the sun but guiding the light in the laboratory and being limited to good weather conditions and daytime is not practical.

Therefore, an optimized spectral response of the light source is desired.

### SUMMARY

The object of the invention is to provide a light source arrangement which allows improved sensor sensitivity measurements. A further object of the invention is to provide a method for providing such a light source arrangement.

With respect to said light source arrangement this object is solved by a light source arrangement according to claim 1. Provided according to the invention is therefore a light source arrangement, especially for sensitivity measurements of color and ambient light sensors, comprising a light source, whereby at least one spectral filter, whereby said filter is built to supress/absorb at least partly at least one part of spectrum of said light source in a prescribed way.

Preferred embodiments are subject of the dependent claims.

The invention is based on the consideration that the precision of sensitivity measurements of ambient light and color sensors needs improvement for current applications of these sensors. There is a demand for smaller variation, resulting in tighter datasheet limits, better yield (tighter guard-bands) and higher test coverage. The spectrum of current light sources does not allow these improvements.

Applicant has recognized that replacing LED light sources by light sources modified by a custom filter results in a significantly decrease of the spread of the sensitivity measurements. For example, in order to obtain spectrally flat spectral response (or any other spectral responses) of the light source special filtering has to be provided. The new light source is especially a combination of plasma pumped light source, halogen light source and special filters (placed in a filter wheel).

Preferably, the at least one filter is configured to suppress the UV and IR part of the spectrum of the light source and to transmit at least partly the visible part of the spectrum of the light source. Sensitivity measurements are thereby separated into visible (pass band, high suppression of UV/IR) and UV/IR (stop band, high suppression of visible) measurements.

The spectral range of wavelengths which pass the at least one filter is in a preferred embodiment set to 350-1100 nm.

The filter in a preferred embodiment is configured such that the light source arrangement provides a flat spectral response in at least part of the visible light spectrum. A flat spectral response in this context means that in a certain region or band of wavelength, the light intensity passing through the filter is essentially constant, while for wavelengths being smaller or larger than the wavelengths in this band, the light intensity passing through the filter is essentially zero. This means that the filter in a wavelength band comprises a constant transmissivity and essentially zero transmissivity outside this band.

The described invention therefore discloses a technical solution to obtain spectrally flat light sources.

In another preferred embodiment the filter is configured such that the light source arrangement provides a positive ramp spectral response in at least part of the visible light spectrum. A positive ramp indicates a wavelength band in which the transmissivity increases with increasing wavelength, especially in a linear way, while outside this band, the transmissivity is essentially zero. Positive or negative spectral ramps are used to check the correct channel assignments (correct filter on correct photodiode).

In another preferred embodiment, the filter is configured such that the light source arrangement provides a negative ramp spectral response in at least part of the visible light spectrum. A negative ramp indicates a wavelength band in which the transmissivity decreases with increasing wavelength, especially in a linear way, while outside this band, the transmissivity is essentially zero.

In a further preferred embodiment, the filter is configured such that the light source arrangement provides a limited-range spectral response in at least part of the light spectrum. A limited-band spectral response means that the transmissivity of the filter is nonzero essentially only in a wavelength band and essentially zero outside of this band. A typical application is to replicate the RGB LED spectral response.

Preferably, the limited-band-spectral response lies in the IR region of the spectrum. In this way, the light source can effectively be used to build a source of IR radiation. Advantageously, the width of the band lies between 750 and 1100 nm, especially is 950 nm. This arrangement is used to measure the stp band performance of the sensor.

Advantageously, the light source is built as a plasma pumped light source. A plasma is generated by a laser, whereby the plasma ball is levitated by means of magnetic fields. The spectral properties of such a light source resemble to some extent the spectral properties of the sun.

This type of light source is very broadband and provides the ability to extract special spectral responses in the visual as well as in the IR region. A possible alternative might be an halogen or incandescent light-source. If the area of interest is visual only, also LED might be an option.

In a preferred embodiment, the at least one filter is arranged in a filter wheel. A filter wheel allows the convention change of filters during a sequence of tests.

With respect to the method, the object is solved by a method according to claim 10. The method comprises the steps of providing a light source, determining the spectral properties this light source, providing desired spectral properties of the light source arrangement, providing at least one filter, and designing the filter such that the optical properties of the filter provide said desired spectral properties of said light source arrangement.

Advantageously, the at least one filter is designed to provide a flat spectral response or a positive ramp spectral response or a negative ramp spectral response or a limited-range spectral response.

Preferably, the said at least one filter is mounted in a filter wheel.

The advantages of the invention are especially as follows. The proposed light source arrangement is suitable for sensitivity measurements of a large variety of ambient light (color) sensors. It can be employed for PC or Laptop displays and has wide range of applications encompassing display color calibration, white point balance, and light brightness sensing. Especially in the blue and red region there is a significant improvement over known methods and light sources. The light source arrangement according to the invention allows a significant reduction of the sensitivity variation.

Based on a higher test accuracy available with the proposed light source arrangement, the data sheet limits can be tightened. The influence of LED variations is eliminated. Higher test accuracy allows tighter guard bands, minimized impact of peak position shifts on sensitivity reading. Single channel trimming becomes feasible. A highly improved accuracy for real sensitivity measurement can be achieved. A higher optical test coverage becomes possible. The individual channel sensitivity can be measured, peak shift measurements become possible.

By employing a light source arrangement according to the invention, the influence of an unwanted filter shift occurring during filter production is significantly reduced. The accuracy of the channel sensitivity measurement is thereby improved. In contrast, for LED sources, a filter shift leads to a big variation in the measurement due to the shape of the LED stimuli.

Beside the classical spectral flat spectral response there are also other spectral responses possible, like positive or negative ramps and IR sources.

### BRIEF DESCRIPTION OF THE PREFERRED EMBODIMENTS

A preferred embodiment of the invention is described in connection with a drawing. In the drawing

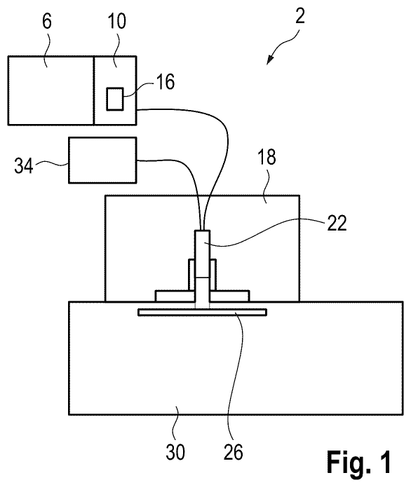

FIG. 1 shows an exemplary testing arrangement with a light source arrangement in a preferred embodiment;

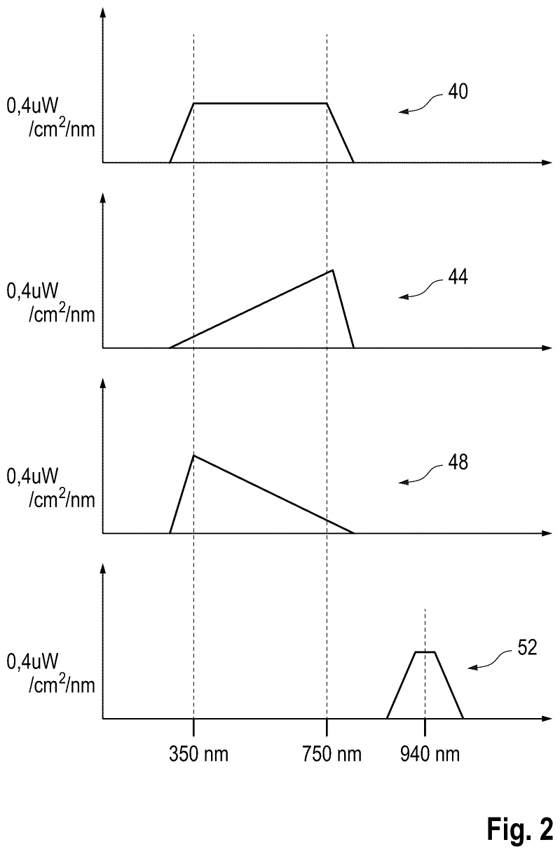

FIG. 2 shows exemplary desired light source properties;

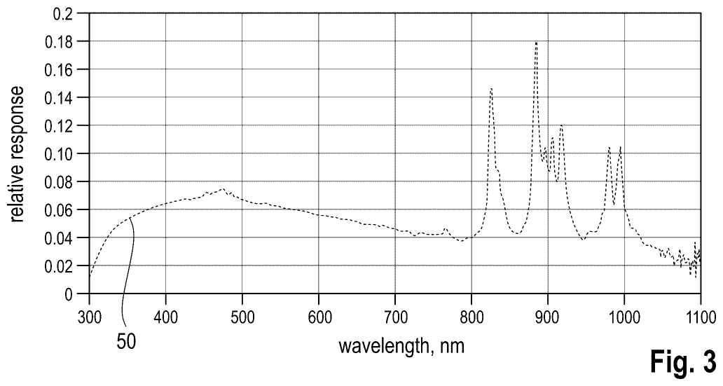

FIG. 3 shows an exemplary spectral distribution of a light source;

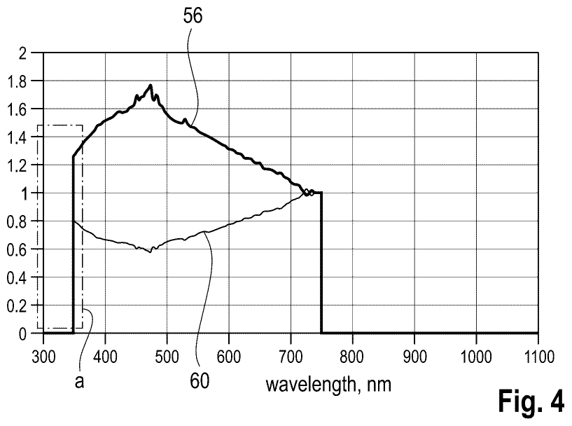

FIG. 4 shows part of the spectral response of the light source and a filter target;

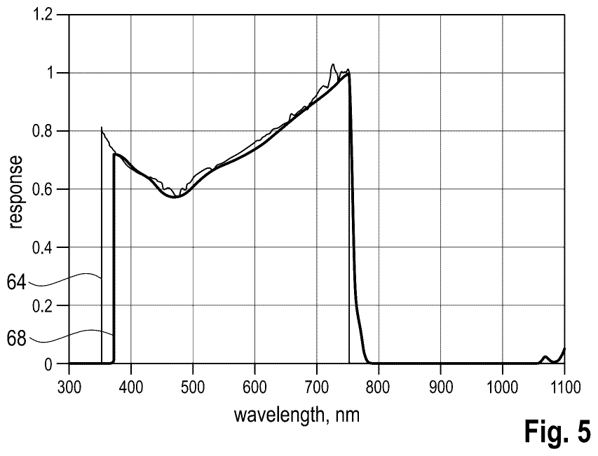

FIG. 5 shows a desired spectral response of a filter and the actual filter spectral response;

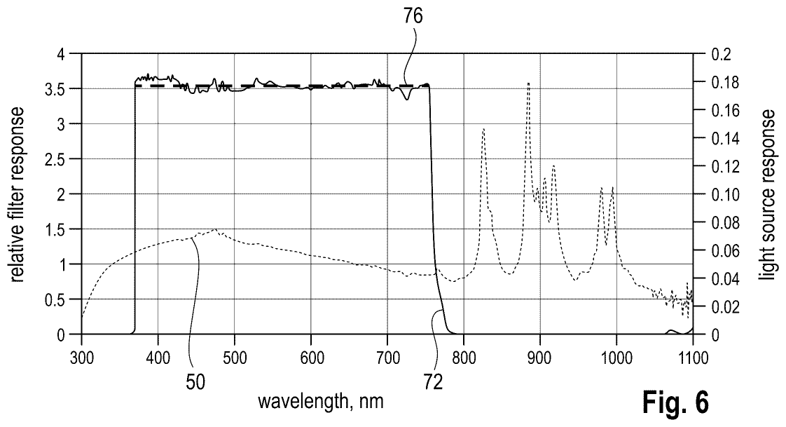

FIG. 6 shows a desired and actual flat filter spectral response;

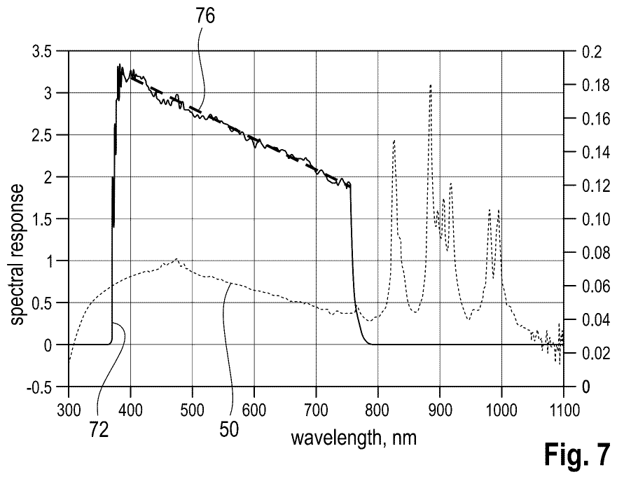

FIG. 7 shows a desired and actual negative ramp filter spectral response;

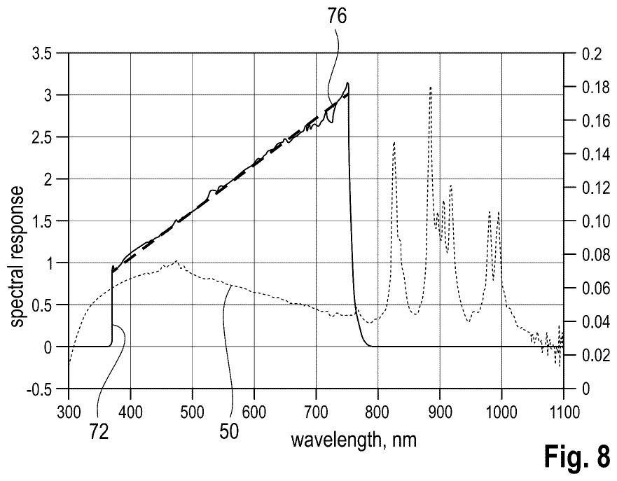

FIG. 8 shows a desired and actual positive ramp filter spectral response, and

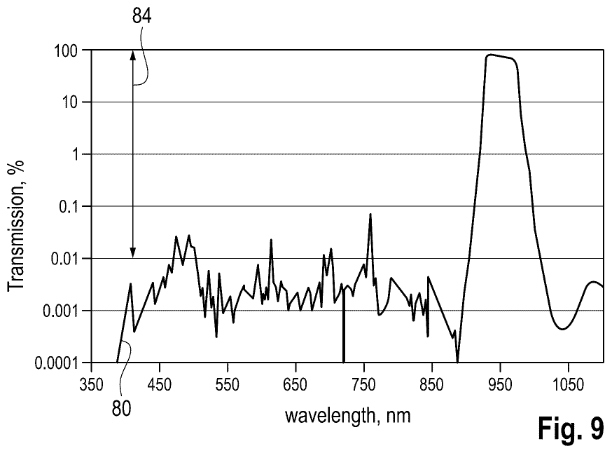

FIG. 9 shows a limited-band IR spectral response of a filter.

Same parts are labelled by identical reference numerals.

### DETAILED DESCRIPTION OF THE PREFERRED EMBODIMENTS

In FIG. 1, an exemplary testing arrangement 2 is shown. The testing arrangement 2 comprises a light source arrangement 6 which comprises a light source 10 and a filter wheel 14 in which at least one filter 16 is arranged. The light from the light source arrangement 6 is transferred into a test head 18 with a light homogenization device 22. The homogenized light is radiated onto a wafer 26 which is transported to the test head 18 by a prober 30. The stimuli are monitored by a spectrometer 34.

In FIG. 2, four possible desired stimuli of a light source arrangement 6 are shown in diagrams. On the x-axis, the wavelength is shown, while on the y-axis, the intensity is shown. From top to bottom, an essentially flat curve 40, a positive ramp 44, a negative ramp 48 and an infrared region 52 or band are shown.

In FIG. 3, with a curve 50, a spectral response of an exemplary light source 10 is shown. On the x-axis of FIG. 3, the wavelength is shown, on the y-axis, the relative l spectral response is shown. The light source in the infrared region comprises several large peaks which in typical applications are not desired.

The principle of the filter design according to the invention is shown in FIG. 4. A first curve 56 shows part of the spectral response of the light source 10. A second curve 60 shows the filter target, i.e., the desired filter absorption characteristics. The filter is essentially constructed with properties inverse to the spectral response of the light source 6 in order to achieve the overall desired spectral response of the light source arrangement 10. In the embodiment shown, the spectral flattening light source filter is designed to suppress the UV and IR wavelength of the spectrum and to transmit the visible light. The combined spectral response with light source is spectrally flat in the visible range.

In FIG. 5, a first curve 64 shows the desired spectral response of the filter, while a second curve 68 shows the actual filter spectral response which very closely matches the desired filter spectral response.

In FIG. 6, by curve 50 the spectral response of the light source 6 (see FIG. 3) is shown. Also shown with a curve 72 is the desired spectral response of the filter corresponding to the flat curve 40 of FIG. 2, while with a curve 76, the actual filter spectral response is shown which matches closely the desired filter spectral response. It can also be seen that the IR and UV regions of the light source 6 are strongly reduced and cut off.

In FIG. 7, by curve 50 the spectral response of the light source 6 (see FIG. 3) is shown. Also shown with a curve 72 is the desired spectral response of the filter which corresponds to the negative ramp 48 of FIG. 2, while with a curve 76, the actual filter spectral response is shown which matches closely the desired filter spectral response. It can also be seen that the IR and UV regions of the light source 6 are strongly reduced and cut off.

In FIG. 8, by curve 50 the spectral response of the light source 6 (see FIG. 3) is shown. Also shown with a curve 72 is the desired spectral response of the filter which corresponds to the positive ramp 44 of FIG. 2, while with a curve 76, the actual filter spectral response is shown which matches closely the desired filter spectral response. It can also be seen that the IR and UV regions of the light source 6 are strongly reduced and cut off.

In FIG. 9, the transmission of a light source arrangement corresponding to the infrared region 52 of FIG. 2 is shown by a curve 80. The y axis is logarithmic scaled. A distance 84 shows +the optical density of OD4.

### LIST OF REFERENCE SIGNS

2 test arrangement
6 light source arrangement
10 light source
14 filter wheel
16 filter
18 test head
22 light homogenization device
26 wafer
30 prober
34 spectrometer
40 flat curve
44 positive ramp
48 negative ramp
50 curve
52 infrared region
56 curve
60 curve
64 curve
68 curve
72 curve
76 curve
80 curve
84 distance

1. A light source arrangement, for sensitivity measurements of color and ambient light sensors, comprising:
a light source; and
at least one spectral filter,
wherein said filter is built to supress at least partly at least one part of spectrum of said light source in a prescribed way.

2. The light source arrangement according to claim 1, wherein
said at least one filter is configured to suppress the UV and IR part of the spectrum of said light source and to transmit at least partly the visible part of the spectrum of said light source.

3. The light source arrangement according to claim 1, wherein the spectral range of wavelengths which pass said at least one filter is set to 350-1100 nm.

4. The light source arrangement according to claim 1, wherein said filter is configured such that said light source arrangement provides a flat spectral response in at least part of the visible light spectrum.

5. The light source arrangement according to claim 1, wherein said filter is configured such that said light source arrangement provides a positive ramp spectral response in at least part of the visible light spectrum.

6. The light source arrangement according to claim 1, wherein said filter is configured such that said light source arrangement provides a negative ramp spectral response in at least part of the visible light spectrum.

7. The light source arrangement according to claim 1, wherein said filter is configured such that said light source arrangement provides a limited-range spectral response in at least part of the light spectrum.

8. The light source arrangement according to claim 7, wherein said limited-band-spectral response lies in the IR region of the spectrum.

9. The light source arrangement according to claim 1, wherein whereby said light source is built as a plasma pumped light source or halogen light source.

10. The light source arrangement according to claim 1, wherein said at least one filter is arranged in a filter wheel.

11. A method for providing a light source arrangement, for sensitivity measurements of sensors, comprising the steps of:
providing a light source;
determining the spectral properties of said light source;
providing desired spectral properties of said light source arrangement;
providing at least one filter; and
designing said filter such that the optical properties of said filter provide said desired spectral properties of said light source arrangement.

12. The method according to claim 11, wherein said at least one filter is designed to provide a flat spectral response or a positive ramp spectral response or a negative ramp spectral response or a limited-range spectral response.

13. The method according to claim 10, wherein said at least one filter is mounted in a filter wheel.
